(19) United States
(12) Patent Application Publication
(10) Pub. No.: US 2020/0063000 A1
(43) Pub. Date: Feb. 27, 2020

(54) ADHESIVE TAPE

(71) Applicant: CERTOPLAST TECHNISCHE KLEBEBÄNDER GMBH, Wuppertal (DE)

(72) Inventors: Peter RAMBUSCH, Wuppertal (DE); Timo LEERMANN, Wuppertal (DE)

(21) Appl. No.: 16/603,261

(22) PCT Filed: Apr. 27, 2018
(86) PCT No.: PCT/EP2018/060913

§ 371 Date: Oct. 7, 2019

(30) Foreign Application Priority Data
May 16, 2017 (DE) 20 2017 102 944.1

(51) Int. Cl. C09J 7/21

(52) U.S. Cl. CPC C09J 7/21; B65H 2701/377; C09J 2201/622; C09J 2467/006; C09J 2203/302; C09J 2400/263

(57) ABSTRACT

The subject of the invention is an adhesive tape, in particular a wrapping tape for bundling cables in automobiles. Said tape is provided with a tape-like carrier and with an adhesive coating applied to all or part of one or two sides of the carrier. The carrier is constructed merely of a planar structure layer on the basis of plastic fibres. According to the invention, the carrier requires a piercing force of more than 0.2 N/m² mass per unit area of the carrier when pierced with a needle having a diameter of 0.14 mm to 0.16 mm.

The invention relates to an adhesive tape, particularly wrapping tape for bundling cables in automobiles, with a substrate strip, and an adhesive coating that is applied to all or part of one or both sides of the strip, the strip being composed of only one textile layer made of plastic filaments.

Adhesive tapes having the above-described construction are widely known from the literature and used in practice. In typical applications, the procedure is such that the substrate strip that is equipped with the adhesive coating and hence the adhesive tape as a whole is wound as a spiral or helix around cables in automobiles to be bundled. That is, the adhesive tape and, in particular, wrapping tape in question is typically used in the manufacture of cable bundles or harnesses for automotive applications, without limitation thereto. The adhesive coating that is applied to the strip can be applied over the entire area or also in strips, i.e. over all or part of the strip.

In addition to a high thermal stability and resistance to chemicals, particularly oil and gasoline, increased abrasion resistance is increasingly required for such tapes or wrapping tapes or wrapping tapes for bundling cables in automobiles. Various approaches exist in the prior art in this respect.

For instance, EP 2 157 147 [US 2010/1048074] describes a highly abrasion-resistant tape in which the strip is of polyamide. In addition, the yarns used to form the textile have a thickness of 280 to 1100 dtex. In addition, each yarn is made up of at least ninety individual filaments. An overall abrasion resistance is to be achieved in this way that meets the standards of so-called class E according to the Automotive Test Guideline LV 312 (February 2008 issue).

Comparable approaches are described in the framework of category-defining EP 1 911 633. This, too, is a cable wrapping tape in which the strip is composed of a single or only one textile layer. This is a textile made of a yarn that is formed from a polyamide. The yarn thickness should be at least 280 dtex. In addition, abrasion class E according to LV 312 is declared to be satisfied.

Finally, the cable wrapping tape according to DE 10 2013 102 602 [US 2014/0272367], which also has a high abrasion resistance as its aim, will also be described in this context. In this case as well, a textile is used for the strip made of a yarn that in turn is made of a polyamide. In addition, the filaments forming the yarn are twisted together about a central longitudinal axis of the yarn. This is intended to further increase the abrasion resistance.

The prior art has fundamentally proven its worth when it comes to the special design of adhesive tapes made of polyamide webs. However, such polyamide webs are relatively expensive to manufacture. In addition, it has been found in practice that the test used in the prior art for determining the abrasion resistance according to the joint test guidelines of the companies Audi, BMW, Daimler Chrysler, and VW, LV 312 “Adhesive tapes for cable harnesses in motor vehicles” (January 2005), is not always and effectively informative. After all, the procedure followed in this context is that the adhesive tape in question is first glued to a mandrel having a diameter of 5 mm or 10 mm. Using a scraper tool with a 0.45 mm needle diameter, the number of strokes required to wear through the adhesive tape is then determined in simultaneous consideration of a pressing force of 7 N. The higher the abrasion resistance, the greater the number of strokes.

In reality, the abrasion resistances of abrasion class E described in the prior art involve strokes numbering in the multiple thousands to more than ten thousand. Consequently, the known abrasion resistance test is time-consuming and cannot be casually carried out and performed “on the fly” as a quality test. What is more, the adhesive tape in question and, in particular, its substrate strip is deformed by the scraping load of the scraping tool or at least undergoes a change in its properties as a result of the actual measuring process. In other words, in addition to being time-consuming, the known test according to specification LV 312 for determining abrasion resistance is also associated with inaccuracies. This is where the invention comes in.

The object of the invention is to provide an adhesive tape of this type that offers increased abrasion resistance while simultaneously opening up the possibility of enabling abrasion resistance to be measured simply and quickly.

To attain this object, a generic adhesive tape and, in particular, wrapping tape for bundling cables in automobiles is characterized in the context of the invention in that the strip requires or withstands a puncture force of greater than 0.2 N per 10 g/m² weight per unit area of the strip with a puncture a needle having a diameter of from 0.14 mm to 0.16 mm.

Thus, unlike the prior art, test guideline LV 312 is not ultimately used according to the invention in order to determine the abrasion resistance of the adhesive tape, but rather a specific puncture test is used as a criterion for abrasion resistance. In this puncture test, a specific puncture force is applied to the previously described needle having a diameter of from 0.14 mm to 0.16 mm. It has been found that adhesive tapes that are especially well suited for use as wrapping tape for bundling cables in automobiles do indeed have the necessary abrasion resistance if a puncture force of greater than 0.2 N per 10 g/m² weight per unit area of the strip is observed.

In contrast to the known test according to the LV 312 standard and the scraping tool used in that test, the puncture test according to the invention has several advantages. For instance, the puncturing can be performed easily and quickly even during production. In addition, due to the small diameter of the needle, it can even be expected that the puncture test in question can be integrated into an existing production line. That is, in contrast to the abrasion resistance test according to LV 312, so destruction or extensive damaging of the tape by the puncture test is not to be expected. Moreover, in the puncture test that is used according to the invention, the adhesive tape does not undergo any changes during the test, such as the compression and the like that can be caused during processing with the scraper tool. In other words, besides reduced wasted time, greater accuracy and better reproducibility can be expected overall.

Furthermore, the puncture test in question can in principle be integrated into the process of making the adhesive tape. This makes it possible, for example, to check procedures for compressing the strip and thereby increasing the puncture resistance directly during the manufacturing process, and the compression can be adapted to the puncture resistance as a feedback control or at least a control system. Such a direct influencing of the abrasion resistance of the strip and consequently of the adhesive tape produced therewith during the manufacturing process or in parallel thereto cannot be achieved with the known abrasion resistance test according to LV 312.

A force to be measured of between 0 and 10 N is typically applied to the needle in question for the puncture test of the specified diameter. The speed of the needle in the puncture test lies in the range between 80 mm and 120 mm/min. The test is carried out using a sample piece of the strip or adhesive tape, the sample piece generally being square with sides measuring about 20 mm.

The sample piece in question is clamped to an underlayment during the puncture test, with the surface of the strip having the adhesive coating facing outward. The underlayment has an opening or a slot having a slot width of about 2 mm to 3 mm in the region of the needle that penetrates through the strip or adhesive tape. For one, this enables the adhesive tape or substrate to lie flat against the underlayment and, for another, this ensures that the needle penetrating through the adhesive tape or substrate does not collide with the underlayment.

In practice, the puncture test described, more particularly the measurement of the puncture force, is largely independent of the composition and even the application weight of the adhesive coating on the strip. After all, the adhesive coating gives the needle practically no resistance. In fact, it is nearly exclusively the strip and the specific design thereof that determines the puncture force, which explains why there has only been mention of the measurement of the puncture force on the adhesive tape as a whole or on the strip, because practically no noteworthy difference is observed de facto and in practice for the reasons set out above.

In order to measure the required puncture force, the needle is thus subjected to increasing force and lowered in each case toward the adhesive tape or substrate that is securely clamped to the underlayment according to the speed indicated above. This procedure is repeated until the needle of the specified diameter of from 0.14 mm to 0.16 mm has punctured the strip or the adhesive tape. The puncture force measured in this way now functions according to the invention as a criterion for the abrasion resistance of the adhesive tape or substrate in question.

It has been found that puncture forces of greater than 0.2 N per 10 g/m² weight per unit area of the strip are generally sufficient to provide adhesive tapes that have the necessary abrasion resistance in practice. This is all the more true in the event that, according to a preferred embodiment, the strip requires a puncture force of greater than 0.3 N per 10 g/m² weight per unit area of the strip. In particular, puncture forces of even greater than 0.5 N per 10 g/m² weight per unit area of the strip are observed in this connection.

The invention as a whole is made based on the discovery that the puncture force depends in largely linear fashion on the weight per unit area of the strip, provided that the strip has a predominantly homogeneous construction. It is for this reason that, according to the invention, the strip is constructed from only one textile layer made of synthetic filaments and, furthermore, in such a way that the synthetic filaments as well as the material thickness of the strip are distributed uniformly over the surface of the strip and define the strip in question. The weight per unit area of the strip is determined in accordance with the standard EN ISO 2286-1 for specific weight. Regarding further information on the relevant regulations, reference is made, for example, to DE 20 2012 104 161 U1, which provides such information.

According to an advantageous embodiment, the strip can be a textile substrate. In this case, the textile substrate is composed of warp yarns and weft yarns, each of which is constructed from the individual plastic filaments of the strip. The plastic surfaces are in fact those that have been produced using interconnected or twisted plastic filaments. It is especially preferred, however, if the strip is a nonwoven substrate. In both cases, it has proven expedient if the plastic filaments of the strip are made wholly or partially of a polyamide.

In fact, embodiments in which the strip is constructed from a mixture of filaments also fall under the invention. For example, polyamide filaments and polyester filaments can be used. The mixed filaments in question are especially advantageously whirled together during nonwoven production. An embodiment in which the plastic filaments of the strip are aromatic polyamide filaments is very especially preferred.

In the context of the invention, the plastic filaments for the textile layer and thus the strip are basically linear, elongate structures made of plastic. In principle, the plastic filament in question can be limited in length and a staple filament. A continuous synthetic-resin filament also falls within the invention. A plurality of plastic filaments can form a plastic yarn. The plastic yarn is composed of one or more plastic filaments that are produced, for example, by twisting together several plastic filaments.

Such filaments of aromatic polyamides are constructed in such a way that polyamides are used here in which the amide groups are bonded to aromatic groups. Such plastic filaments of aromatic polyamides or polyamides are sold in practice under various trade names such as “Kevlar” or “Twaron.”

In any event, plastic filaments for producing the strip on the basis of aromatic polyamides or so-called “aramids” are characterized by very high strength, high impact resistance, high rupture attenuation, and good vibration damping, which is why adhesive tapes that are specially constructed from them are ideally suited for use as wrapping tape for bundling cables in automobiles. What is more, such plastic filaments are designed to be extremely heat-resistant and withstand temperatures of several hundreds ° C. as sometimes observed in the automotive sector. In fact, appropriately designed substrates can be exposed to temperatures of greater than 100° C., sometimes even of greater than 150° C., and especially preferably of greater than 200° C. In that case, thermally stable adhesives must of course also be used for the adhesive coating in order to ensure the overall functionality of the adhesive tape at such temperatures.

If the strip is embodied especially preferably as a nonwoven substrate, a treatment of the nonwoven substrate for the purpose of a physical bonding has proven expedient. The physical bonding can be carried out in such a way that the nonwoven substrate is needled, for example by water jets. Needling with air jets or combined needling with water jets and air jets is also possible and also falls within the invention. Treatment by calendering by (heated) rollers is also conceivable. Even stitching with yarns and the realization of a so-called cotton fleece are also covered by the invention.

Alternatively or in addition, the nonwoven substrate can also be bonded chemically. Chemical bonding typically makes use of an incorporated binder. The bonding methods described and specified above are well known in the art, which is why no further details will be discussed in this respect, especially since conventional approaches are used.

As another possibility for the physical bonding of the strip or nonwoven substrate, the invention proposes that the nonwoven substrate have a plurality of stabilizing yarns running continuously at least in the longitudinal warp direction of the strip as constituents of a yarn mesh. The stabilizing yarns in question can be arranged on the surface of the nonwoven substrate or, in general, of the textile layer and/or in the interior thereof. In the context of the invention, the term “stabilizing yarn” does not refer only to a textile, linear structure made of twisted or spun natural or synthetic filaments, but rather also includes continuous filaments or filaments as well as staple filaments. Finally, the term “stabilizing yarn” can also subsume filaments of finite length, so-called “staple filaments.” Advantageously, however, continuous fibers or filaments are used as stabilizing yarns, here particularly plastic filaments that are composed of aromatic polyamides. The plastic filaments in question can be twisted together to define the stabilizing yarns as a whole. That is, the plastic filaments used to produce the stabilizing yarns can also be yarns that are made of plastic filaments or aromatic polyamide filaments. Mixed filaments such as polyamide filaments and polyester filaments for making the stabilizing yarns are also conceivable and included.

The stabilizing yarns are components of a yarn mesh. Such a mesh is a spatially defined and determined arrangement of the stabilizing yarns in the interior and/or on the surface of the laminar substrate or textile layer. The yarn mesh in question is characterized in that at least two of the stabilizing yarns run continuously in the tape longitudinal direction. Additional stabilizing yarns can then be added for this purpose that also extend in the tape longitudinal direction and/or transverse thereto. It is also conceivable for the additional stabilizing yarns to be loop-shaped. The stabilizing yarns are arranged for the most part in the interior of the textile layer.

The additional provision of the yarn mesh provides the advantage that, particularly if the adhesive tape is elongated in the longitudinal direction or in the tape warp direction, any constrictions or excessive reduction in width are avoided. Instead, the yarn mesh that is introduced or applied imparts a special structural stability to the adhesive tape of the invention, including and particularly in case of a tensile load in the longitudinal direction. This also applies particularly to a case in which the stabilizing yarns are constructed from plastic filaments made of polyamides.

The strip generally has a weight per unit area of 40 g/m² and more. As a rule, the weight per unit area is in the range between about 60 g/m² and about 250 g/m². As for the plastic filaments or the plastic yarns produced therefrom, a thickness of greater than 20 dtex is observed. Preferably, the thickness can assume values of 50 dtex and more. An especially preferred range of the thickness of the plastic filaments or plastic yarns is between 100 dtex and about 1000 dtex. As will readily be understood, plastic filaments in the form of spun-bonded nonwoven filaments with a thickness of less than 10 dtex can also be used.

As a result, an adhesive tape is provided that has an especially high resistance to abrasion. The adhesive tape can be a wrapping tape for bundling cables in automobiles, i.e. a cable wrapping tape used for the spiral or helical wrapping of cable sets as described in EP 1 911 633 cited above. In addition, however, it is also possible with the aid of the adhesive tape according to the invention to form a sheath or longitudinal sleeve or covering in a manner commensurate inter alia with the subject matter of EP 2 157 147, to which reference was already made in the introduction to the description.

In contrast to the prior art, the abrasion resistance is determined with the aid of a puncture test as a criterion. In practice, such puncture tests are performed for films or for packaging material in general, for example. Noteworthy in this respect are the puncture tests according to EN 14477, in which the puncture resistance of films to a point having a diameter of 0.8 mm is measured. Similar tests are described in the standard ASTMF 1306 but have hitherto not been put to practical use for adhesive tapes, particularly as a criterion for abrasion resistance.

In contrast to the procedure according to LV 312, the measurement of the puncture force and the corresponding puncturing method are characterized in that the test can be carried out relatively quickly and without much effort. To wit, the puncture test described enables specimens to be easily taken and examined for quality assurance immediately before processing. Herein lie the fundamental advantages.

### EMBODIMENT

1. A specimen, more particularly a square sample piece with a side length of about 20 mm and a weight per unit area of 60 g/m², is produced and clamped on the above-described underlayment for the purpose of measuring puncture resistance or puncture force. The sample piece of the first example is formed with a substrate that is made of a polyester nonwoven that is additionally reinforced with sewing yarns in a manner comparable to a so-called “Maliwatt.” The individual synthetic filaments of the polyester nonwoven are staple fibers.

The measured puncture force is 0.16 N. Made of the weight per unit area of 60 g/m², this results in a puncture force of about 0.03 N per 10 g/m² weight per unit area of the strip composed of the polyester nonwoven.

The puncture force of this adhesive tape according to the prior art thus falls short of the puncture force of greater than 0.2 N per 10 g/m² required according to the patent by nearly a factor of 10.

2. In contrast, as a comparative and second example, an adhesive tape according to the invention was examined for puncture resistance. In this case, an aramid nonwoven backing is used as the strip, the nonwoven or nonwoven substrate being bonded by water jet needling. For purposes of comparison, the weight per unit area of the strip is about 60 g/m² here as well.

The puncture force measured here is 4.7 N. This results in a puncture force of 0.78 N per 10 g/m2 weight per unit area of the strip, so that the inventive limit of 0.2 N/10 g/m² weight per unit area of the strip is clearly exceeded.

1. An adhesive tape, particularly wrapping tape for bundling cables in automobiles, the tape comprising:
a substrate strip, and
an adhesive coating that is applied to all or part of one or both sides of the strip, the strip being composed of only one textile layer made of plastic filaments, the strip requiring a puncture force of greater than 0.2 N per 10 g/m² weight per unit area of the strip with a puncture needle having a diameter of from 0.14 mm to 0.16 mm.

2. The adhesive tape according to claim 1, wherein the strip requires a puncture force of greater than 0.3 N per 10 g/m² weight per unit area of the strip.

3. The adhesive tape according to claim 1, wherein the plastic filaments of the strip are composed entirely or partially of a polyamide.

4. The adhesive tape according to claim 3, wherein the plastic filaments of the strip are aromatic polyamide filaments.

5. The adhesive tape according to claim 1, wherein the strip is constructed from mixed polyamide filaments and polyester filaments.

6. The adhesive tape according to claim 1, wherein the strip is a textile substrate or nonwoven substrate.

7. The adhesive tape according to claim 6, wherein the nonwoven substrate is physically bonded by being sewn over with yarns and/or needled with water jets and/or air jets and/or calendered by rolling.

8. The adhesive tape according to claim 6, wherein the nonwoven substrate is chemically bonded by application of binder.

9. The adhesive tape according to claim 1, wherein the strip has a weight per unit area of at least 40 g/m².

10. A method of testing a wrapping tape for bundling cables in a motor vehicle, the method comprising the step of:
securing a sample piece of the wrapping tape to an underlayment over a groove or opening therein;
pressing against the secured tape on the underlayment a needle having a tip with a diameter of from 0.14 mm to 0.16 mm;
increasing and monitoring the force applied by the tip to the underlayment; and
determining the applied force when the needle pierces the tape.

11. The method according to claim 10, further comprising the step of:
approving for use the tape when the determined force exceeds 0.2 N per 10 g/m² weight per unit area of the strip
